(19) United States
(12) Patent Application Publication
(10) Pub. No.: US 2009/0188467 A1
(43) Pub. Date: Jul. 30, 2009

(54) Method for using ordinary fuel and water for car engine

(76) Inventors: Hendrik Loggers, Amerongen (NL); Gijsbert Versteeg, Nunspeet (NL)

Correspondence Address: H. Loggers, Prinses Beatrixlaan 19, Amerongen, XJ 3958, NL

(21) Appl. No.: 12/288,445

(22) Filed: Oct. 21, 2008

(30) Foreign Application Priority Data
Oct. 23, 2007 (NL) 1034572

(51) Int. Cl. F02B 47/02

(52) U.S. Cl. 123/25 C

(57) ABSTRACT

The invention consists of the application of both fuel and water in engines and is characterised by the simultaneous vaporisation of these substances using one or more injection pumps of the type used for diesel and petrol injection engines.

The fuel could be petrol, diesel, vegetable oil or another appropriate substance. Demineralised water is preferred to ordinary water. Blends of various fuels can also be used. The quantity of fuel and air can be adjusted for the proper operation of the engine.

According to the method, water is transformed into high-pressure steam. The phase transformation requires relatively little energy. This energy can be obtained from the fuel which is transferred into the engine. The pressure of the steam and the gases which are released with the fuel explosion provide kinetic energy.

### BACKGROUND OF THE INVENTION

1. Field of the Invention

The invention consists of the application of both fuel and water in engines and is characterised by the simultaneous vaporisation of these substances using one or more injection pumps of the type used for diesel and petrol injection engines.

2. Brief Summary of the Invention

The invention consists of the application of both fuel and water in engines and is characterised by the simultaneous vaporisation of these substances using one or more injection pumps of the type used for diesel and petrol injection engines.

The fuel could be petrol, diesel, vegetable oil or another appropriate substance. Demineralised water is preferred to ordinary water. Blends of various fuels can also be used. The quantity of fuel and air can be adjusted for the proper operation of the engine.

According to the method, water is transformed into high-pressure steam. The phase transformation requires relatively little energy. This energy can be obtained from the fuel which is transferred into the engine. The pressure of the steam and the gases which are released with the fuel explosion provide kinetic energy.

### DETAILED DESCRIPTION OF THE INVENTION

According to this method, water is transformed into high-pressure steam. The phase transformation requires relatively little energy, and this can be obtained from the fuel which is transferred into the engine. The pressure of the steam and the gases which are released during the fuel explosion provide kinetic energy.

The use of fuel as well as water in engines is characterised by their simultaneous vaporisation in the motor cylinder. The use of fuel as well as water can be found in Dutch patent 4616 in the name of Adriaan Frederik van Amstel in which fuel is first ignited in a pre-combustion chamber, after which water is injected into that chamber. These substances are then atomised in the cylinder as a result of the blasting of the gases which are created in the pre-combustion chamber.

According to the method of this patent, an injection pump of the kind used in diesel and petrol injection engines causes the vaporisation, and this can generate a very high vaporisation pressure. Dutch patent 50065 in the name of Christian Wilhelm Paul Heylandt describes a method whereby steam is added to an engine.

The fuel which can be applied includes petrol, diesel and vegetable oil or other appropriate substances. Demineralised water is preferred above the use of ordinary water. Various fuel blends can also be applied.

For example:

| No. | Petrol % | Diesel % | Soya oil % | Water % |
|---|---|---|---|---|
| 1 | 20 | — | — | 80 |
| 2 | 3.3 | 10.7 | 11.6 | 74.4 |
| 3 | 6.25 | 22.4 | — | 70.35 |
| 4 | 5 | 30 | — | 65 |
| 5 | 17.5 | 17.5 | — | 65 |
| 6 | 15.25 | 30.5 | — | 54.25 |
| 7 | 20 | 34 | — | 46 |
| 8 | 5 | 51.7 | — | 43.3 |
| 9 | — | 56.9 | — | 43.1 |
| 10 | 7.86 | 52.8 | — | 39.3 |
| 11 | 8.06 | 8.06 | 9.7 | 74.2 |
| 12 | 35 | — | — | 65 |
| 13 | 42.7 | — | — | 57.3 |

Fuel and water (or a combination of fuel and water) can be pumped into the engine using the same pump or can be injected separately using an injection pump.

In order to vary the composition of the blend, an electrically-regulated valve can be installed in the water supply line to the pump. The amount of air necessary for the proper operation of the engine is determined by the engine manufacturer. This quantity is greater than is necessary for the fuel fraction, so that it must be possible to adjust the amount of air, for which control equipment will be necessary. The alternative for fixing the oxygen required for the fuel fraction is to adjust the input gas by mixing air and a portion of the emission gases.

1. Method for using water as well as fuel in an engine, characterised by the simultaneous vaporisation of water and fuel in an engine cylinder, using an injection pump as used in automobile technology.

2. Method according to conclusion 1 with the characteristic that water for vaporisation is injected using an injection pump other than the pump with which fuel is injected.

3. Method according to conclusion 1 or 2 with the characteristic that the ratio between the components is regulated using (an) adjustable valve(s) in the supply line(s) to the pump(s).

4. Method according to one of the above conclusions with the characteristic that the method provides for means of regulating the amount of oxygen in the air to be sucked in.
